(19) United States
(12) Patent Application Publication
(10) Pub. No.: US 2024/0356046 A1
(43) Pub. Date: Oct. 24, 2024

(54) DISTRIBUTOR PLATE FOR AN ELECTROCHEMICAL CELL, AND ELECTROCHEMICAL CELL

(71) Applicant: Robert Bosch GmbH, Stuttgart (DE)

(72) Inventor: Ulrich Berner, Stuttgart (DE)

(21) Appl. No.: 18/682,230

(22) PCT Filed: Jul. 28, 2022
(86) PCT No.: PCT/EP2022/071190

§ 371 Date: Feb. 8, 2024

(30) Foreign Application Priority Data
Sep. 3, 2021 (DE) 10 2021 209 735.9

(51) Int. Cl. H01M 8/026; H01M 8/0228; H01M 8/10

(52) U.S. Cl. CPC H01M 8/026; H01M 8/0228; H01M 8/10; H01M 2008/1095

(57) ABSTRACT

The invention relates to a distribution plate (7) for an electrochemical cell (1), wherein the distributor plate (7) has a structure comprising bridges (12), each having a top surface (13), and main channels (11) each having a base surface (33), wherein the top surface (13) has at least one secondary channel (15) and a coating (37) that covers at least parts of the at least one secondary channel (15), and the coating (37) is at least partially porous, in particular water-permeable, and optionally hydrophilic. The invention further relates to an electrochemical cell (1).

### BACKGROUND

The invention relates to a distributor plate for an electrochemical cell, wherein the distributor plate has a structure comprising bridges, each having a top surface, and main channels each having a base surface. Furthermore, the invention relates to an electrochemical cell.

Electrochemical cells are electrochemical energy transducers and are known in the form of fuel cells or electrolyzers.

A fuel cell converts the chemical reaction energy of a continuously supplied fuel and an oxidizing agent into electrical energy. In known fuel cells, hydrogen (H₂) and oxygen (O₂) are in particular converted to water (H₂O), electrical energy, and heat.

Proton-exchange membrane (PEM) fuel cells are known, among others. Proton-exchange membrane fuel cells comprise a centrally arranged membrane that is permeable to protons, i.e. hydrogen ions. The oxidizing agent, in particular atmospheric oxygen, is thereby spatially separated from the fuel, in particular hydrogen.

Fuel cells comprise an anode and a cathode. The fuel is supplied to the fuel cell at the anode and catalytically oxidized with loss of electrons to form protons that reach the cathode. The lost electrons are discharged from the fuel cell and flow via an external circuit to the cathode.

The oxidizing agent, in particular atmospheric oxygen, is supplied to the fuel cell at the cathode and reacts to form water by receiving the electrons from the external circuit and protons. The resulting water is drained from the fuel cell. The gross reaction is:

O₂+4H⁺+4e⁻→2H₂O

A voltage is in this case applied between the anode and the cathode of the fuel cell. In order to increase the voltage, a plurality of fuel cells can be mechanically arranged one behind the other to form a fuel cell stack, which can also be referred to as a fuel cell system, and can be electrically connected in series.

A stack of electrochemical cells typically has end plates that press the individual cells together and impart a stability onto the stack. The end plates can also serve as a positive or negative pole of the stack for discharging the current.

The electrodes, i.e. the anode and the cathode, and the membrane can be structurally assembled to form a membrane-electrode assembly (MEA).

Stacks of electrochemical cells further comprise bipolar plates, also referred to as gas distributor plates or distributor plates. Bipolar plates serve to distribute the fuel evenly to the anode and to distribute the oxidizing agent evenly to the cathode. Furthermore, bipolar plates usually have a top surface structure, in particular channel-like structures, for distributing the fuel and the oxidizing agent to the electrodes. In particular in fuel cells, the channel-like structures also serve to drain the water produced during the reaction. In addition, the bipolar plates can comprise structures for passing a cooling medium through the electrochemical cell in order to discharge heat.

In addition to the media guidance with respect to oxygen, hydrogen, and water, the bipolar plates ensure a planar electrical contact to the membrane.

For example, a fuel cell stack typically comprises up to a few hundred individual fuel cells stacked one on top of the other in layers as so-called sandwiches. The individual fuel cells comprise one MEA and a bipolar plate half on both the anode side and the cathode side. In particular, a fuel cell comprises an anode monopolar plate and a cathode monopolar plate, typically each in the form of embossed sheets, which together form the bipolar plate and thus form channels for guiding gas and liquids, between which the cooling medium flows.

Furthermore, electrochemical cells typically comprise gas diffusion layers for gas distribution. The gas diffusion layers are arranged between a bipolar plate and a MEA and are typically constructed on the channel side, i.e., in the direction of the adjacent bipolar plate, from a carbon fiber nonwoven fabric, which is also referred to as “gas diffusion backing” (GDB), and on the catalyst side, i.e., in the direction of the membrane, from a microporous layer, which is also referred to as “micro porous layer” (MPL).

In contrast to a fuel cell, an electrolyzer is an energy converter, which, while applying electrical voltage, preferably splits water into hydrogen and oxygen. Electrolyzers also have MEAs, bipolar plates, and gas diffusion layers, among other things.

For the efficiency of an electrochemical cell, in particular with a polymer electrolyte membrane, it is particularly important to homogeneously supply reaction gas to the electrode layers arranged on the membrane.

Known distributor plates in particular have channels and respectively abutting or adjacent bridges that form a structure. The channels are also referred to as main channels or channels and the bridges can be called lands. Top surfaces of the bridges at least partially parallel to the extension plane of the distributor plate comprise contact top surfaces of the distributor plate to an adjacent gas diffusion layer of the electrochemical cell. Gaseous hydrogen and oxygen pass the gas diffusion layer from the channels of the distributor plate to the reaction zone on the membrane. The regions of the gas diffusion layer, which rest on the bridges of the distributor plate and thus the corresponding regions of the underlying MEA, are supplied comparatively poorly with reaction gas, in particular under flooding conditions of the electrochemical cell, which can lead to an undesirable inhomogeneous current density distribution.

On the side of the membrane at which air, i.e. oxygen, is supplied, water is produced in the operation of the fuel cell, which must be transported through the gas diffusion layer to the channels of the distributor plate and removed from the cell there. Typical operating temperatures for electrochemical cells having a membrane are less than 120° C., so the water typically condenses at least partially in the gas diffusion layer and is present in liquid form. In the gas diffusion layer, the transport direction of the water is opposite to the transport direction of the gas, and accumulated water can severely impede the feeding of reaction gas, in particular oxygen.

The structure of the gas diffusion layers makes it difficult to naturally drain the water, which is typically present in liquid form at high current densities, so that water back-up can occur, in particular under the bridges. This can limit the power density of the electrochemical cell in the contact regions.

The higher the power density of the electrochemical cell, the more water is produced, so the discharge of the amounts of liquid water in the contact region between the gas diffusion layer and air channel side of the distributor plates may be insufficient.

JP 2020-47441 A describes an improved drainage system for bipolar plates in which additional flutes are provided in flanks of the bridges parallel to the direction of the main channels.

JP 2020-47443 A describes bipolar plates with improved water drainage, wherein bridges of the bipolar plates have an additional channel system arranged transversely to the direction of the main channels. Each of two channels of the additional channel system has a common drain. Furthermore, transverse structures in main channels of a distributor plate are disclosed, which, however, lead to a high pressure loss.

JP 2020-47440 A also relates to bipolar plates with an improved drainage system, wherein the bridges have notches transverse to the direction of the main channels and additional flutes along the flanks of the connecting portions parallel to the direction of the main channels.

Furthermore, a coating of distributor plates is known.

### SUMMARY

A distributor plate for an electrochemical cell is proposed, wherein the distributor plate has a structure comprising bridges, each having a top surface, and main channels each having a base surface, wherein the top surface has at least one secondary channel and a coating that covers at least parts of the at least one secondary channel, and the coating is at least partially porous, in particular water-permeable, and optionally hydrophilic.

Furthermore, an electrochemical cell comprising the distributor plate is proposed.

Preferably, the electrochemical cell, which is preferably a fuel cell or an electrolyzer, preferably comprises at least one distributor plate according to the invention, at least one gas diffusion layer, and at least one membrane or membrane-electrode arrangement. In particular, a respective gas diffusion layer is arranged between a distributor plate and a membrane.

The gas diffusion layer preferably has an open-porous structure. Preferably, the membrane is a polymer-electrolyte membrane having, for example, perfluorosulfonic acid (PFSA), in particular nafion, or consists of perfluorosulfonic acid (PFSA), in particular nafion. Furthermore, alkaline membranes can also be used.

Preferably, the gas diffusion layer comprises a nonwoven fabric, in particular a carbon fiber nonwoven fabric, and optionally a microporous layer, in which case the nonwoven fabric is arranged on a side of the gas diffusion layer facing the distributor plate. Further preferably, the gas diffusion layer consists of the carbon fiber nonwoven fabric and optionally the microporous layer.

The distributor plate preferably has carbon such as graphite, a metal such as stainless steel or titanium, and/or an alloy containing the metal. Further preferably, the distributor plate is constructed of carbon, metal, and/or alloy. In particular, a base plate of the distributor plate is made of carbon, the metal, and/or the alloy.

The at least one secondary channel can also be referred to as a drainage channel, capillary channel, flute, or as a microscopically small, flute-like structure and serves to discharge resulting reaction water in the main channel. The at least one secondary channel is in particular arranged on one side of the distributor plate, which faces in the direction of an adjacently arranged gas diffusion layer in the electrochemical cell.

The distributor plate, which can also be referred to as a bipolar plate, preferably has a wave-like structure, in which case bridges and main channels alternate and are further preferably arranged parallel to one another.

Preferably, the top surface of the bridges has at least one contact region, which can also be referred to as a contact top surface, against which the adjacently arranged gas diffusion layer abuts. Preferably, the contact regions of the bridges are arranged substantially parallel to the base surfaces of the main channels. Here, “substantially parallel” is to be understood in that a plane in which the contact regions lie and the base surfaces enclose an angle of less than 30°, further preferably less than 20°, more preferably less than 10°, and in particular less than 5°.

Preferably, the bridges have lateral top surfaces, which are in particular enclosed by the top surface of the bridges. The top surface of the bridges further preferably comprises two lateral top surfaces per bridge, each connecting to a base surface of the adjacent main channel. The lateral top surfaces can also be referred to as flanks and are preferably arranged at a flank angle in relation to the base surfaces, wherein the flank angle is further preferably in a range from 90° to 135°, more preferably in a range from 90° to 125°, particularly preferably from 95° to 110°. Furthermore, the lateral top surfaces are preferably arranged at an angle to the contact regions.

Preferably, the base surfaces are planar. “Planar” also refers to top surfaces that only have a slight wave shape and/or a slight rounding due to the production process, in particular due to the embossing process. The main channels are preferably arranged straight and further preferably parallel to one another on the distributor plate.

The at least one secondary channel has a cross-sectional top surface area, which is preferably triangular, i.e. V-shaped, round, square, or polygonal. Preferably, the cross-sectional top surface of the at least one secondary channel is V-shaped. Preferably, a cross-sectional surface area of the main channels is greater by at least a factor of fifty than a cross-sectional surface area of the at least one secondary channel.

In particular, a ratio of a secondary channel height to a secondary channel width is in a range from 2:1 to 1:2, further preferably from 1.5:1 to 1:1.5. For example, the ratio of the secondary channel height to the secondary channel width is 1:1. The secondary channel height and/or the secondary channel width are preferably in a range from 1 μm to 100 μm, further preferably in a range from 1 μm to 50 μm.

Furthermore, in particular the secondary channel height and the secondary channel width or the diameter of the at least one secondary channel are selected, such that the at least one secondary channel forms a capillary effect, in particular with regard to water. The term “diameter” is in particular understood to mean the largest diameter of the cross-sectional top surface area.

The coating on the bridges preferably has a height in a range from 0.01 μm to 50 μm, further preferably from 1 μm to 20 μm. Preferably, the coating is more hydrophilic at least in partial areas than a material of the base plate of the distributor plate. The term “hydrophilic” is preferably understood to mean that the contact angle with respect to water droplets is less than 90°, more preferably that the contact angle with respect to water droplets is less than 80°, in particular less than 40°. The coating serves in particular to lower the electrical contact resistance of the distributor plate on the top surface of the bridges. Preferably, the coating completely covers the top surface of the bridges, in particular the contact regions.

Preferably, the coating, in particular on the contact regions of the bridges, comprises carbon such as carbon black or graphite, in particular carbon particles, and a binder, in particular an organic binder, for example at least one polymer such as polyethylene (PE) or polyvinylidene fluoride (PVDF), in particular PE. The binder can be thermoplastic or thermosetting.

Applying the coating to the distributor plate may comprise applying a paste and subsequent drying.

Furthermore, the coating may comprise in particular conductive ceramic particles, which may be applied in a sintering step.

The coating can have a hydrophilic component, for example, oxidized carbon particles having hydroxide, carbonyl, and/or carboxyl groups, with a polymeric binder, which is particularly applicable for carbon distributor plates. Furthermore, hydrophilic top surface properties can be produced, for example, by a top surface treatment with, for example, oxygen or acid.

The at least one secondary channel is preferably introduced into the base plate of the distributor plate, which is in particular a sheet metal, for example by embossing, etching or laser work.

In particular, the distributor plate comprises the at least one secondary channel before the coating is applied to the distributor plate. The coating covers the at least one secondary channel, in particular laminarly, such that an interruption of the contact region between the distributor plate and the gas diffusion layer, which would arise in the absence of the coating due to the at least one secondary channel, is avoided. Accordingly, the at least one secondary channel is preferably located between the distributor plate and the coating. Further preferably, the at least one secondary channel forms a cavity between the coating and the top surface. Accordingly, the coating preferably does not follow the contour of the at least one secondary channel. Further preferably, the coating extends, in particular planar, over the at least one secondary channel.

Preferably, the bridges each have a contact region and the at least one secondary channel is completely covered or overlaid by the coating in the contact regions. By covering the at least one secondary channel with the coating, an interruption or a gap in the contact region between the distributor plate and the gas diffusion layer is avoided, as contact to the gas diffusion layer is maintained via the coating across the at least one secondary channel.

In one embodiment, the coating is only partially porous, in particular water-permeable, and optionally hydrophilic, wherein further preferably a porous region of the coating is arranged at least partially on the at least one secondary channel. In particular, the porous region covers the at least one secondary channel, such that water penetrating through the coating can flow into the at least one secondary channel. In particular, carbon particles and a binder may form at least the porous region of the coating.

“Water permeable” is particularly understood to mean that water, in particular coming from the gas diffusion layer, can overcome the coating in the direction of the at least one secondary channel.

Preferably, the at least one secondary channel is at least partially in the contact region of the bridges. In a preferred embodiment, the at least one secondary channel extends to a lateral top surface of the bridges and optionally to the base surface of a main channel, in particular an adjacent main channel. The at least one secondary channel, which is extended in this sense, allows the water to be discharged beyond the contact region onto the base surface into the area of the gas flow.

Preferably, the at least one secondary channel has a straight path. The straight path may have a change of direction, which may also be referred to as a buckle or may be rounded.

The top surface may comprise at least two secondary channels, wherein the at least two secondary channels may be arranged at different angles, which may also be referred to as angle of attack, to the main channels, and may optionally intersect. Preferably, the secondary channels each intersect in the porous region of the coating. The angle of attack is preferably in a range of 30° to 150°, further preferably 90° to 120°.

In a preferred embodiment, the at least one secondary channel is arranged substantially parallel or substantially perpendicular to the main channels.

The term “substantially parallel” is understood in particular to mean that the at least one secondary channel runs or is arranged at an angle of less than 45°, more preferably less than 30°, further preferably less than 10°, and in particular preferably less than 5° to the main channels, in particular to an adjacent main channel, in particular to a main flow direction in the main channel. The term “main flow direction” refers to the gas transported in the main channel, in particular to an oxygen-containing gas that receives the resulting reaction water for removal. The main flow direction preferably runs parallel to the lateral top surfaces of the adjacent bridges.

Accordingly, the term “substantially perpendicular” is understood to mean that the at least one secondary channel extends or is arranged at an angle in a range from 45° to 135°, more preferably from 60° to 120°, further preferably from 80° to 100°, and in particular preferably from 85° to 95°, to the main channels, in particular an adjacent main channel.

Preferably, the top surface, in particular a bridge, comprises at least one first secondary channel and at least one second secondary channel, wherein the at least one first secondary channel is arranged substantially parallel to the main channels and the at least one second secondary channel is arranged substantially perpendicular to the main channels. The at least one first secondary channel is further preferably arranged centrally on the contact region, i.e. along a central axis of the contact region.

Preferably, at least two secondary channels are connected to each other by a further secondary channel. In particular, the further secondary channel intersects the at least two secondary channels. Furthermore, it is preferred that the top surface, in particular of a bridge, comprises at least two second secondary channels and at least one first secondary channel connects the at least two second secondary channels to one another.

The various embodiments can be combined with one another.

The at least one secondary channel on the top surface of the bridges serves to improve the removal of liquid water that has formed on the membrane of the electrochemical cell and must be transported out of the electrochemical cell. Water must be removed from the gas diffusion layer in the direction of the main channels, at the same time maximizing the contact region between the distributor plate and the gas diffusion layer through the coating and being particularly continuous planar.

The coating bridges the contact region via the at least one secondary channel and water can be removed despite the intact contact region by the at least partially porous, in particular water permeable and optionally hydrophilic configuration of the coating. The coating guides water into the underlying, at least one secondary channel, wherein the full bridge top surface is retained as contact to the gas diffusion layer.

### BRIEF DESCRIPTION OF THE DRAWINGS

Embodiments of the invention are explained in greater detail with reference to the drawings and the following description.

Shown are:

FIG. 1 a schematic illustration of an electrochemical cell according to the prior art,

FIG. 2 a fuel cell setup with distributor plates,

FIG. 3 a contact region between a gas diffusion layer and a distributor plate,

FIG. 4 a section of a distributor plate according to the prior art,

FIG. 5 a section of a distributor plate with coating,

FIG. 6, 7 a section of a distributor plate with coating and secondary channel,

FIG. 8 a section of a distributor plate with secondary channel and partially porous coating,

FIG. 9 a section of a distributor plate with interconnected secondary channels and partially porous coating,

FIG. 10 a section of a distributor plate with a coating and secondary channels with different angles of attack,

FIG. 11 a section of a distributor plate with a coating and intersecting secondary channels,

FIG. 12 a section of a distributor plate with a coating and secondary channels with a change of direction,

FIG. 13 a section of a distributor plate with a coating and interconnected secondary channels with a change of direction,

FIG. 14 solid top surfaces having different top surface properties, and

FIG. 14d a contact angle with respect to water.

### DETAILED DESCRIPTION

In the following description of the embodiments of the invention, identical or similar elements are denoted by identical reference numbers, wherein a repeated description of these elements is omitted in individual cases. The drawings illustrate the subject matter of the invention in a schematic manner only.

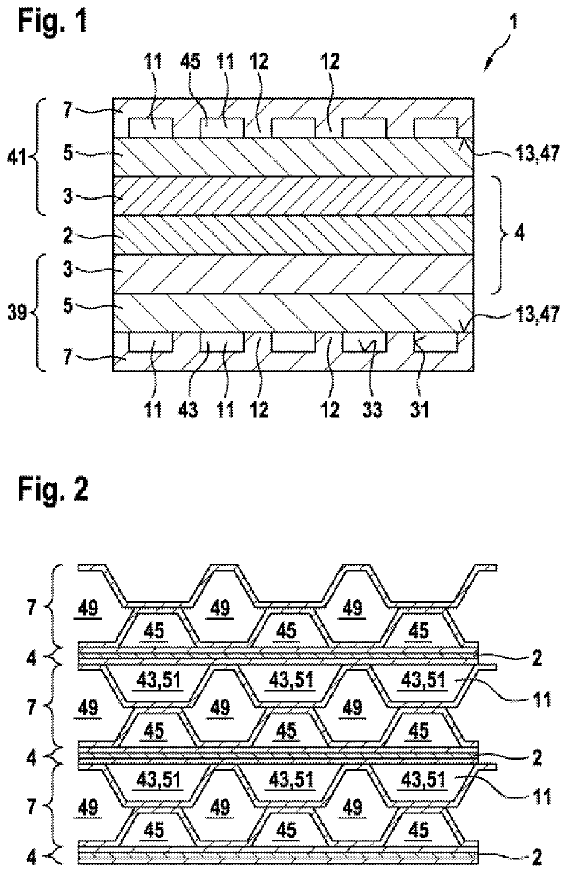

FIG. 1 schematically shows an electrochemical cell 1 in the form of a fuel cell according to the prior art. The electrochemical cell 1 has a membrane 2 as electrolytes. The membrane 2 separates a cathode space 39 from an anode space 41.

A respective electrode layer 3, a gas diffusion layer 5, and a distributor plate 7 are arranged on the membrane 2 in the cathode space 39 and anode space 41. The connection of the membrane 2 and the electrode layer 3 can also be referred to as a membrane-electrode assembly 4.

The distributor plates 7 have main channels 11 for gas supply, for example of oxygen 43 in the cathode space 39 and hydrogen 45 in the anode space 41, to the gas diffusion layers 5. Main channels 11 and bridges 12 alternate on the distributor plates 7.

On a top surface 13 of the bridges 12, a respective contact region 47 is formed between the distributor plate 7 and the adjacently arranged gas diffusion layer 5. Furthermore, the bridges 12 have lateral top surfaces 31 and the main channels 11 have base surfaces 33.

FIG. 2 shows a fuel cell setup comprising a plurality of distributor plates 7 and membrane electrode assemblies 4 having membranes 2. Oxygen 43, or air in which oxygen 43 is contained, and hydrogen 45 are guided to the membrane-electrode assemblies 4 through the distributor plates 7. Water 51 is discharged in the main channels 11 of the distributor plates 7 in which oxygen 43, or air in which oxygen 43 is contained, is supplied. In addition, the distributor plates 7 serve to guide a coolant 49.

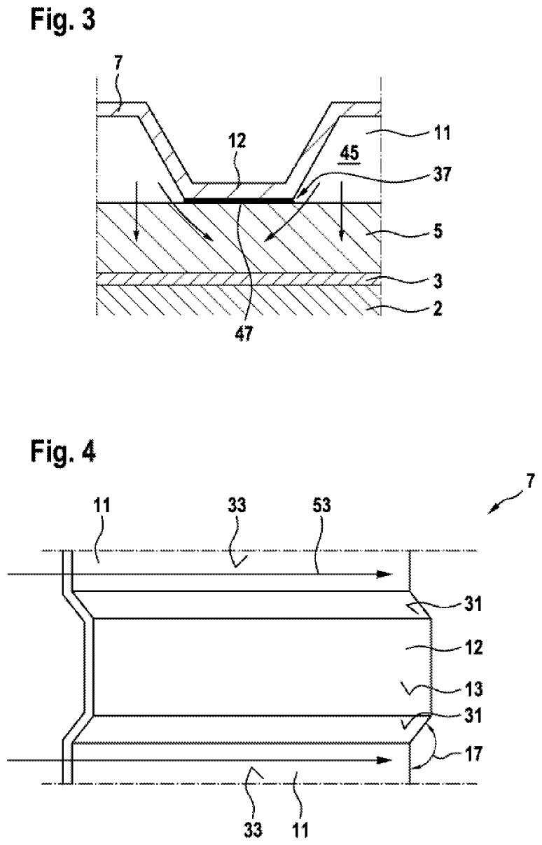

FIG. 3 shows a contact region 47 between a gas diffusion layer 5 and a distributor plate 7. A bridge 12 of the distributor plate 7 is in contact with the gas diffusion layer 5 here. Furthermore, a coating 37 is arranged on the bridge 12 of the distributor plate 7. Hydrogen 45 passes from the main channels 11 through the gas diffusion layer 5 to the electrode layer 3, which is arranged on the membrane 2.

FIG. 4 shows a top perspective view of a section of a distributor plate 7, which comprises main channels 11 and bridges 12 in alternation. A main current direction 53 is present along the main channels 11. Furthermore, a flank angle 17 is labeled.

The bridges 12 have a top surface 13, of which the parts arranged at an angle to the base surfaces 33 of the main channels 11 are referred to as lateral top surfaces 31. The base surfaces 33 of the main channels 11 connect to the lateral top surfaces 31 of the bridges 12.

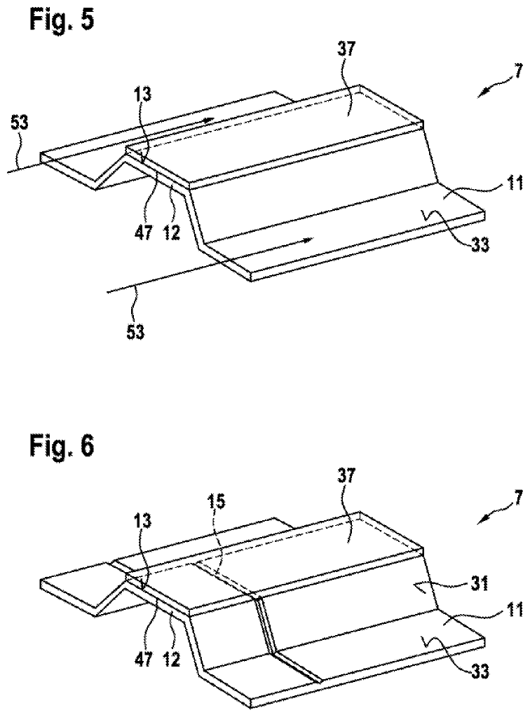

FIG. 5 shows a section of a distributor plate 7, which has a coating 37 on a top surface 13 of the bridges 12 in the contact region 47.

FIG. 6 shows a section of a distributor plate 7, substantially according to FIG. 5, which comprises a secondary channel 15, which is completely covered by the porous coating 37.

FIG. 7 shows the section of the distributor plate 7 according to FIG. 6, wherein the transport of water 51 from the contact region 47 of the bridges 12 in the secondary channel 15 along the lateral top surfaces 31 into the main channel 11 is shown. To this end, the secondary channel 15 extends to the lateral top surface 31 of the bridge 12 as well as to the base surfaces 33 of the main channel 11. The water 51 drains from the contact region 47 along the lateral top surface 31 in the secondary channel 15 onto the base surface 33.

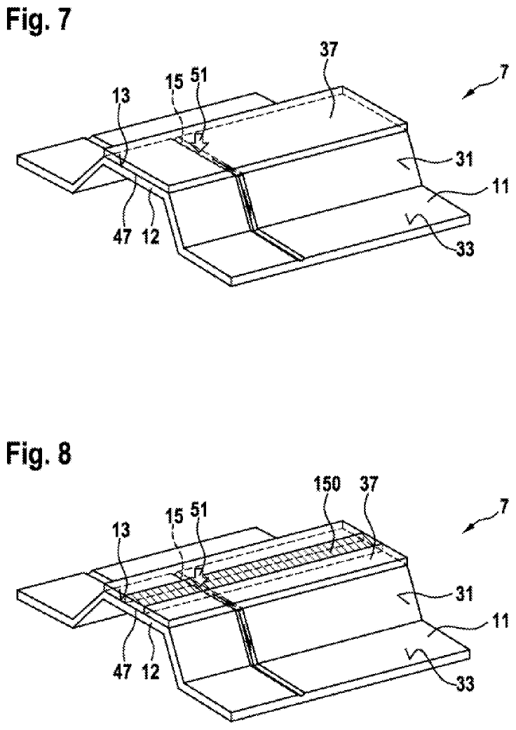

FIG. 8 shows a section of a distributor plate 7, which substantially corresponds to FIG. 7, wherein the coating 37 is only partially porous here and has a porous region 150. The porous region 150 overlaps with the secondary channel 15 so that water 51 can drain into the secondary channel 15 through the porous region 150.

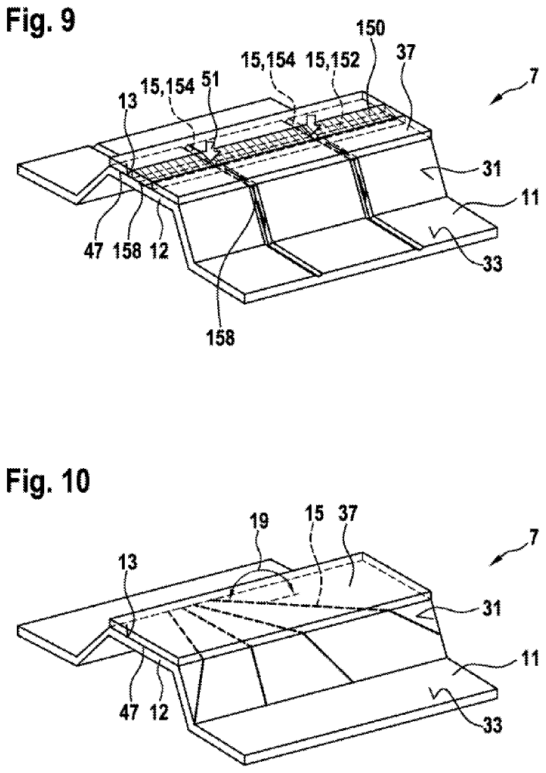

FIG. 9 shows a section of a distributor plate 7 with a total of three secondary channels 15. A first secondary channel 15, 152 is arranged parallel to the main channel 11 and further centrally on the contact region 47. Two second secondary channels 15, 154 are arranged perpendicular to the main channel 11. The first secondary 15, 152 connects the second secondary channels 15, 154 with each other, wherein the first secondary channel 15, 152 intersects the second secondary channels 15, 154 in the porous region 150 of the coating 37. Water 51 can drain from the first secondary channel 15, 152 into the main channel 11 via the second secondary channels 15, 154. The cavities 158 between the coating 37 and the top surface 13 in which the water 51 can flow can be seen.

FIG. 10 shows a section of a distributor plate 7, wherein four secondary channels 15 are arranged under the coating 37, each aligned at a different angle 19, which can also be referred to as an angle of attack, with respect to the main channel 11.

FIG. 11 shows a section of a distributor plate 7, on which the secondary channels 15 each have different angles 19 and intersect.

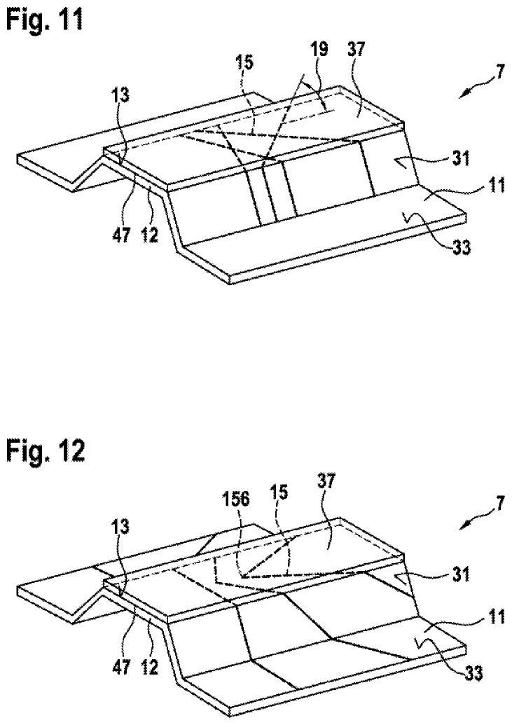

FIG. 12 shows a section of a distributor plate 7 on which two secondary channels 15 have a straight path with a change of direction 156.

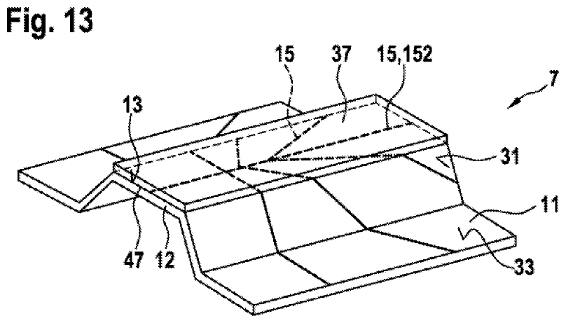

FIG. 13 shows a section of a distributor plate 7 on which the secondary channels 15, partially with a change of direction 156, are connected to each other by a first secondary channel 15, 152, which is arranged parallel to the main channel 11.

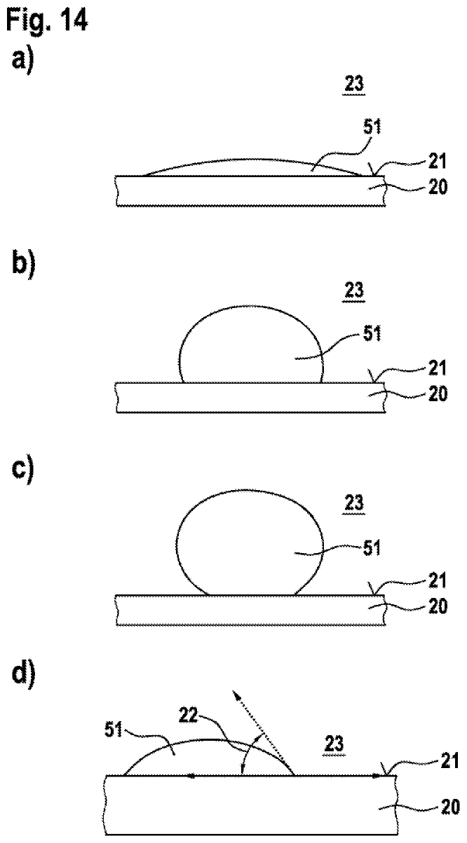

FIG. 14 shows the solid 20 with solid top surfaces 21 having different top surface properties with respect to a drop of water 51 surrounded by a gas phase 23. The solid top surfaces 21 shown have a) hydrophilic, b) hydrophobic, and c) superhydrophobic top surface properties.

FIG. 14d illustrates a contact angle 22 with respect to water 51 on a solid 20 with a solid top surface 21.

The invention is not limited to the embodiment examples described herein and the aspects emphasized thereby. Rather, a variety of modifications, which are within the scope of activities of the person skilled in the art, is possible within the range specified by the claims.

1. A distributor plate (7) for an electrochemical cell (1), wherein the distributor plate (7) has a structure, comprising bridges (12), each having a top surface (13), and main channels (11) each having a base surface (33), wherein the top surface (13) has at least one secondary channel (15) and a coating (37) that covers at least parts of the at least one secondary channel (15), and the coating (37) is at least partially porous.

2. The distributor plate (7) according to claim 1, wherein the at least one secondary channel (15) forms a cavity (158) between the coating (37) and the top surface (13).

3. The distributor plate (7) according to claim 1, wherein the bridges (12) each comprise a contact region (47) and the at least one secondary channel (15) is completely covered by the coating (37) in the contact regions (47).

4. The distributor plate (7) according to claim 1, wherein the coating (37) is only partially porous and a porous region (150) of the coating (37) is arranged at least partially on the at least one secondary channel (15).

5. The distributor plate (7) according to claim 1, wherein the at least one secondary channel (15) extends to a lateral top surface (31) of the bridges (12).

6. The distributor plate (7) according to claim 1, wherein the at least one secondary channel (15) has a straight path.

7. The distributor plate (7) according to claim 1, wherein the top surface (13) comprises at least two secondary channels (15) and the at least two secondary channels (15) are arranged at different angles (19) to the main channels (11).

8. The distributor plate (7) according to claim 1, wherein the top surface (13) comprises at least one first secondary channel (15, 152) and at least one second secondary channel (15, 154), wherein the at least one first secondary channel (15, 152) is arranged substantially parallel to the main channels (11) and the at least one second secondary channel (154) is arranged substantially orthogonally to the main channels (11).

9. The distributor plate (7) according to claim 7, wherein the at least two secondary channels (15) are connected to each other by a further secondary channel (15).

10. An electrochemical cell (1) comprising a distributor plate (7) according to claim 1.

11. The distributor plate (7) according to claim 1, wherein the coating (37) is water-permeable.

12. The distributor plate (7) according to claim 11, wherein the coating (37) is hydrophilic.

13. The distributor plate (7) according to claim 5, wherein the at least one secondary channel (15) extends to the base surface (33) of a main channel (11).

14. The distributor plate (7) according to claim 1, wherein the at least one secondary channel (15) includes a change of direction (156).

15. The distributor plate (7) according to claim 7, wherein the at least two secondary channels (15) intersect.
